(19) United States
(12) Patent Application Publication
(10) Pub. No.: US 2006/0045198 A1
(43) Pub. Date: Mar. 2, 2006

(54) Single reference clock design for radios used in wireless MIMO communication systems

(76) Inventors: David P. Magee, Plano, TX (US); Michael T. DiRenzo, Coppell, TX (US)

Correspondence Address: TEXAS INSTRUMENTS INCORPORATED, P O BOX 655474, M/S 3999, DALLAS, TX, 75265, US

(21) Appl. No.: 10/929,704

(22) Filed: Aug. 30, 2004

(51) Int. Cl. H04L 1/02

(52) U.S. Cl. 375/267

(57) ABSTRACT

A system and method are provided for eliminating the relative phase behavior in the transmitter and receiver radios employed in a wireless MIMO communication system. The method employs a single synthesizer and allows multiple transceivers to function with the same RF reference frequency source and/or IF reference frequency source. Since each transceiver has the same RF and/or IF reference frequency, each transceiver experiences the same phase noise. Thus, the phase noise for the MIMO transmitter is now bounded by the single synthesizer. The same relative phase behavior occurs in the receive portion as well.

### BACKGROUND OF THE INVENTION

1. Field of the Invention

This invention relates generally to wireless communication systems, and more particularly to a system and method of eliminating the relative phase behavior in the transmitter and receiver radios for all of the radios in a wireless multiple input multiple output (MIMO) communication system.

2. Description of the Prior Art

The phase noise associated with a single wireless radio can be determined from the specifications for the synthesizer. When multiple radios are combined however, to form a MIMO system transmitter, the phase noise becomes a multi-dimensional problem. First, the synthesizers will lock at different times creating a phase difference between the outputs of each synthesizer. Second, the independent phase noise processes of each synthesizer result in a dynamic variation of the relative phase between the synthesizer outputs. This causes the radio signals to randomly add constructively and/or destructively depending on the relative phase of the synthesizers and the statistical properties of the phase noise. Preamble design for MIMO systems is one area where this effect is important because designs may require the simultaneous transmission of the same symbol or scalar multiples (i.e. +1 and −1) of the same symbol using multiple radios.

More specifically, the relative phase between the communication channels, which include the transmitter and receiver radios, can impact the amplitude of the signals coming out of a MIMO transmitter and going into a MIMO receiver. Depending upon the radio configuration, the phase effect can impact the MIMO preamble and the MIMO data in many different ways. The type of signaling in the preamble for AGC training, coarse frequency estimation, fine frequency estimation, FFT placement, channel estimation, phase tracking, legacy SIGNAL decode and data decode are just a few of the areas that will be affected by the relative phase in the communication channels.

In view of the foregoing, it is highly desirable and advantageous to provide a technique for eliminating the relative phase behavior in the transmitter and in the receiver radios employed in a wireless MIMO communication system.

### SUMMARY OF THE INVENTION

The present invention is directed to a system and method of eliminating the relative phase behavior in the transmitter and in the receiver radios employed in a wireless MIMO communication system. The solution employs a single synthesizer and allows multiple transceivers to function with the same RF reference frequency source and/or IF reference frequency source. Since each transceiver has the same RF and/or IF reference frequency, each transceiver experiences the same phase noise. Thus, the phase noise for the MIMO transmitter is now bounded by the single synthesizer. The same relative phase behavior occurs in the receive portion as well.

In one aspect, a system and method are implemented to provide a single synthesizer approach to bound the phase noise for multiple radios in MIMO wireless communication systems.

In another aspect, a system and method are implemented to transform a MIMO phase noise problem into a SISO phase noise problem.

In yet another aspect, a system and method are implemented to reduce the number of synthesizers while simultaneously eliminating the relative phase behavior in the transmitter and in the receiver radios employed in a wireless MIMO communication system.

In still another aspect, a system and method are implemented to simplify the phase tracking algorithms in the receiver portion of a wireless MIMO communication system.

In still another aspect, a system and method implement frequency switched or frequency orthogonal preambles for MIMO communication systems, thus allowing higher data throughput.

According to one embodiment, a multiple input multiple output (MIMO) wireless communication system comprises:
a single reference oscillator;
no more than one synthesizer, the no more than one synthesizer generating a reference frequency signal in response to the single reference oscillator; and
a plurality of wireless transceivers, each wireless transceiver within the plurality of wireless transceivers responsive to the reference frequency signal and a base band signal to generate RF data.

According to another embodiment, a wireless communication system comprises:
means for generating a sole reference frequency output signal; and
a plurality of wireless transceivers, each wireless transceiver within the plurality of wireless transceivers responsive to the sole reference frequency output signal and a base band signal to generate RF data.

According to yet another embodiment, a wireless communication system comprises:
means for generating a sole reference frequency output signal; and
a plurality of wireless transceivers, each wireless transceiver within the plurality of wireless transceivers operational to transmit and receive base band and RF data in response to the sole reference frequency output signal and further in response to data selected from the group consisting of RF data, and base band data.

According to still another embodiment, a method of wireless communication comprises the steps of:
providing a single synthesizer configured to generate a RF reference frequency output signal in response to a single reference frequency oscillator; and
operating a plurality of transceivers to generate RF data in response to the RF reference frequency output signal and further in response to incoming base band data.

According to still another embodiment, a method of wireless communication comprises the steps of:
providing a single synthesizer configured to generate an IF reference frequency output signal in response to a single reference frequency oscillator; and
operating a plurality of transceivers to generate base band data in response to the IF reference frequency output signal and further in response to incoming RF data.

According to still another embodiment, a method of wireless communication comprises the steps of:
providing a single synthesizer configured to selectively generate a reference frequency output signal in response to a single reference frequency oscillator, the reference frequency output signal selected from the group consisting of a RF reference signal, and an IF reference signal; and
operating a plurality of transceivers to generate RF data when the reference frequency output signal is a RF reference signal and further to generate base band data when the reference frequency output signal is an IF reference signal.

### BRIEF DESCRIPTION OF THE DRAWINGS

Other aspects and features of the present invention and many of the attendant advantages of the present invention will be readily appreciated as the invention becomes better understood by reference to the following detailed description when considered in connection with the accompanying drawings in which like reference numerals designate like parts throughout the figures thereof and wherein:

FIG. 1 is a block diagram of the data path for a two transmitter and a single receiver experimental setup;

FIG. 2 is a block diagram illustrating the transmit portion of a conventional MIMO transceiver system;

FIG. 3 is a block diagram showing the demodulation process of the combined signal from RF to BB in the receiver portion of a MIMO transceiver system;

FIG. 4 is a diagram illustrating an initial 2×2 MIMO preamble associated with a two transmitter system;

FIG. 5 illustrates one resulting time-switched preamble for a two transmitter system;

FIG. 6 is a block diagram illustrating the transmit portion of a MIMO transceiver system according to one embodiment of the present invention; and

FIG. 7 is a block diagram illustrating the receive portion of a MIMO transceiver system according to one embodiment of the present invention.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

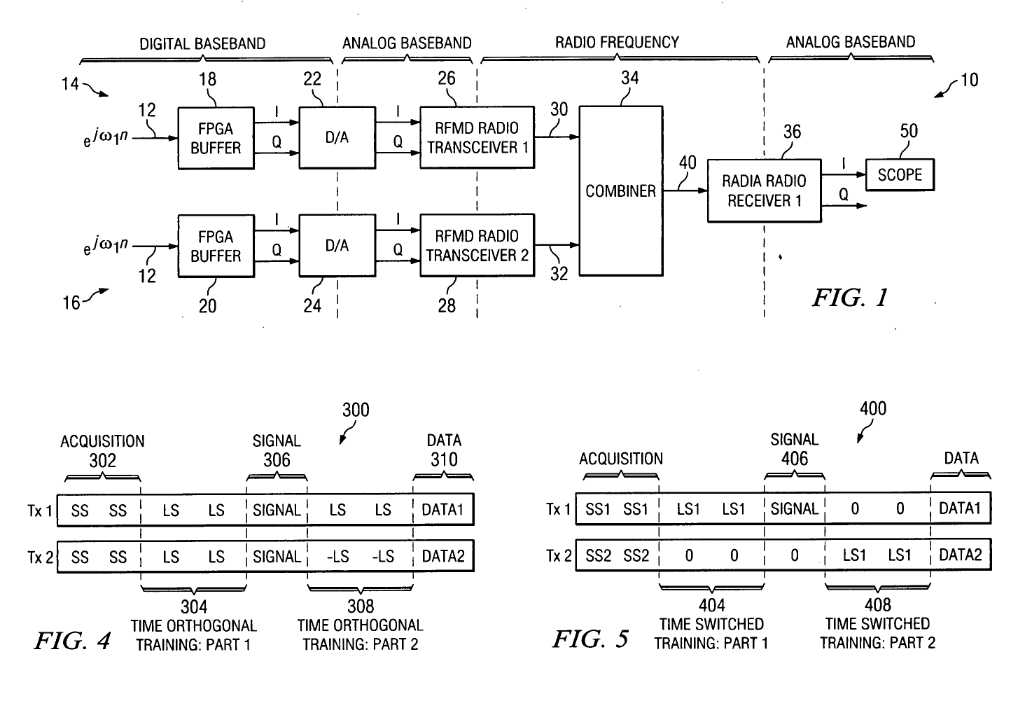

FIG. 1 shows a block diagram of the data path for a two transmitter and a single receiver experimental setup 10 that is first described herein below in order to facilitate a better understanding of the preferred embodiments described herein. A single tone waveform (i.e. e^{jω}^{₁}ⁿ) 12 at 312.5 kHz was generated by the present inventors and stored in a 256 point FPGA (Field Programmable Gate Array) buffer. The transmit logic was configured to continuously cycle through this buffer. That is, once the last point in the buffer has been transmitted, the next point to be transmitted is the first point in the buffer. Each transmit path 14, 16 has its own time-domain buffer 18, 20, which has been loaded with the same data. Since the transmit logic for each path 14, 16 is triggered by the same signal 12, the transmit signals are synchronized.

Each FPGA buffer 18, 20 feeds its own respective AFE (Analog Front-End) with the I (In-Phase) and Q (Quadrature) data samples, which are D/A converted 22, 24 and then transferred to each RFMD radio 26, 28. At this point, the data is up-converted to an IF frequency of 374 MHz and then up-converted to an RF frequency of 2.412 GHz. The RF outputs 30, 32 are wired to a combiner (such as a Pasternack PE2026) 34 whose output is wired to the input of the radio 36.

Once the signal is in the receive path 40 of the radio 36, it is down converted to an IF frequency of 374 MHz and then down converted to BB (Base Band). A high speed sampling scope 50 was used to monitor the I (In-Phase) and Q (Quadrature) base band (BB) analog signals.

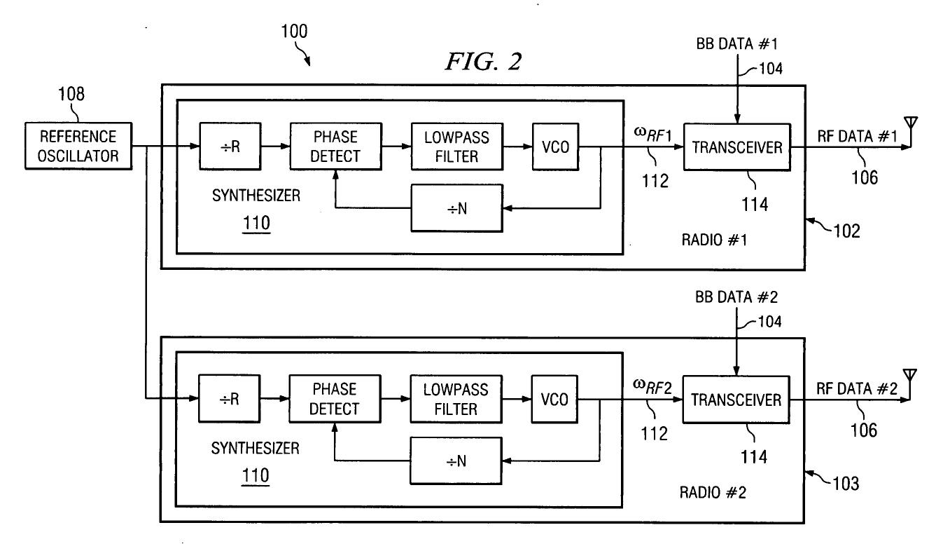

Looking now at FIG. 2, a block diagram illustrates the transmit portion 102, 103 of a conventional MIMO transceiver system 100 that converts data from base band 104 to a radio frequency 106 using a single reference oscillator 108. Each transmit portion 102, 103 can be seen to employ a unique synthesizer 110. The IF portion of the synthesizer 110 has been omitted to simplify the following discussion. Since each synthesizer 110 is connected to the same reference clock 108, the assumption is that each radio's transceiver 114 will have the same RF reference frequency 112 (given that each synthesizer 110 is the same). This assumption however, is not exactly true because each radio 102, 103 experiences a different disturbance profile. It can be assumed with modeling simplifications however, that each radio 102, 103 operates with the same nominal frequency. Further, the synthesizers 110 will not lock at the same time, which creates a relative phase between the transmit paths even though each RF frequency is correct. This problem becomes worse as more transmit paths are added to the MIMO system 100.

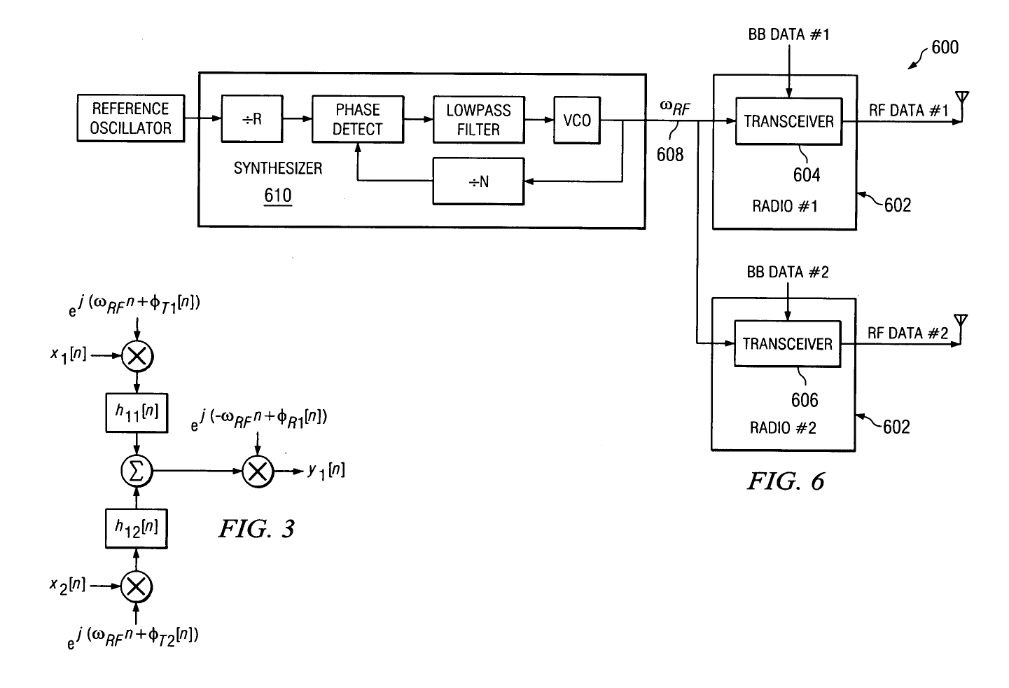

The modulation process from BB to RF in the transmitter can be represented graphically by multiplying the BB data by a phasor as shown in FIG. 3. The phase of the modulation phasor, Φ, for transmitter 1, enumerated as 102 therefore, can be written as
Φ_{T1}[n]=ω_{RF}·n·Φ_{T1}[n] (1)
where the subscript T1 denotes transmitter 1, n denotes the discrete-time sample, ω_{RF} denotes the RF frequency in radians/sample and Φ_{T1}[n] is the angle response due to phase noise at transmitter 1 in radians. It should be noted that the initial condition of the phase response is a function of when the PLL (Phase Locked Loop) in the synthesizer 110 has locked.

Similarly, the phase of the modulation phasor for transmitter 2, enumerated as 103 can be written as
Φ_{T2}[n]=ω_{RF}·n·φ_{T2}[n] (2)

FIG. 3 also shows the demodulation process of the combined signal from RF to BB in the receiver. The phase of the demodulation phasor for receiver 1 can be written as
Φ_{R1}[n]=−ω_{RF}·n·φ_{R1}[n] (3)
where the subscript R1 denotes receiver 1.

The BB signal at the receiver can be approximated by the following time domain expression:
y₁[n]=h₁₁[n]\hat{x}x₁[n]e^{j(φ}^{_{T1}}^{[n]+φ}^{_{R1}}^{[n])}+h₁₂[n]\hat{x}x₂[n]e^{j(φ}^{_{T2}}^{[n]+φ}^{_{R1}}^{[n])} (4)
where yᵢ[n] denotes the BB data at the i^{th} receiver, hᵢⱼ[n] denotes the impulse response of the channel from the j^{th} transmitter to the i^{th} receiver, xⱼ[n] denotes the BB data from the j^{th} transmitter and \hat{x} denotes convolution. This form of the received BB data will be used to describe experimental data herein below.

Analysis of equation (4) above indicates that the magnitude and phase responses of each channel can greatly impact the magnitude and phase of the received signal. The magnitude responses are very similar (i.e. appear as AWGN and Ricean channels) for many indoor wireless channels. As a result, the phase response of the channel, transmit radio and receive radio become important. Determining the angle response due to phase noise in radio synthesizers however, can be a very difficult process. Synthesizer specifications often provide a phase noise plot as a function of the offset frequency with respect to the carrier frequency in units of dBc/Hz. This plot represents the amount of phase noise measured in dB with respect to the carrier frequency for each 1 Hz bandwidth from the carrier frequency (i.e. for each offset frequency). Most synthesizer specification however, only show a curve for frequency offsets greater than 100 Hz, which tends to bias the integrated phase error numbers found in most specifications towards medium to high frequency effects.

For wireless SISO (Single Input, Single Output) communication systems, the low frequency effects (i.e. those less than 100 Hz) are often ignored because only a single stream of data is transmitted using a single radio. As a result, the channel estimation process can easily track these low frequency synthesizer effects. Low frequency effects for wireless MIMO systems however, become more important because multiple streams of data are being transmitted simultaneously. Preamble designs, as a result, must consider these effects to ensure proper operation of the AGC training, course frequency correction, fine frequency correction, FFT placement, channel estimation and signal decode algorithms, as stated herein before. A discussion of relevant low frequency effects that can occur when using multiple transmit radios is presented herein below to provide a better understanding of the embodiments described herein and to provide a better understanding of these effects on the overall MIMO communication system and algorithm design.

Using the experimental setup 10 shown in FIG. 1, the AGC in the receiver 36 was locked to a nominal value and the base band I signal at the receiver 36 was recorded for each transmitter. A 20 dB pad was added to transmit path 14 and a 18 dB pad was added to transmit path 16 to ensure that each signal had the same power at the receiver 36. (The padding was biased by 18 dB so that the wired signal did not saturate the receiver 36). Subsequent to adjusting the power of each transmitted signal, the wires were connected as shown in FIG. 1 so that the combined signal could be captured. The present inventors discovered that the two signals appear to add constructively and destructively. Since the channels are wires in experimental setup 10, they were modeled as AWGN channels. The received BB signal for the I phase can therefore be written as
Re{y₁[n]}=A₁ cos(ω₁n+φ[n])+A₂ cos(ω₁n+φ₂[n]) (5)
where φ₁[n]=φₙ[n]+φ_{R1}[n] and xᵢ[n]=Aᵢe^{jω}^{₁}ⁿ. Since the transmit paths were calibrated, as stated herein before, the cosine amplitudes are assumed to be the same (i.e. A₁=A₂≡A). The mathematical form of the cosine wave therefore becomes

$$Re \{ y [ n ] \} = 2 A cos ( \frac{{ϕ}_{1} [ n ] - {ϕ}_{2} [ n ]}{2} ) cos ( {ω}_{1} n + \frac{{ϕ}_{1} [ n ] - {ϕ}_{2} [ n ]}{2} ) \qquad ( 6 )$$

Under the foregoing assumptions, the amplitude of the cosine wave was found to change because the difference between the two transmitter phase angles is changing (i.e. φ₁[n]−φ₂[n] is changing). The present inventors found a 16.7 dB change in the receive power, and that the signal power stays at roughly the same level for several seconds before finally returning to more of a random behavior. This random phase behavior of the radios that causes these large amplitude fluctuations over long time periods was found also to cause large fluctuations over short time periods.

In summary explanation, two primary effects must be considered when designing and implementing RF paths for MIMO communication systems. They will effect the type of training and signaling that can be used in the system. The first effect is the relative phase between the RF paths in the transmitter and the receiver. For RF paths with their own synthesizers, this phase difference depends on when each synthesizer locks. The second effect is the amplitude fluctuations due to changes in relative phase. The bounds for the fluctuations can be determined from the phase noise specifications of the synthesizer. The relative phase value, in essence, will set the nominal operating point; and deviations from the relative phase value will dictate the amount of amplitude fluctuation from the nominal operating point.

The present inventors found that multiple RF synthesizers can vary the amplitude of a received tone by up to 16 dB. When the amplitude of each transmitted tone is the same, changes in the relative phase between multiple transmitters will produce amplitude fluctuations in the received signal. By applying this effect to all of the tones in an OFDM symbol, it can be shown that simultaneous transmission of the same OFDM symbol from multiple radios can potentially degrade wireless MIMO system performance. This issue becomes important during the design of MIMO preambles.

Looking now at FIG. 4, a diagram illustrates an initial 2×2 MIMO preamble 300 associated with a two transmitter system. The preamble 300 has been divided into several sections: acquisition 302, time orthogonal training: part 1 (304), signal 306, time orthogonal training: part 2 (308) and data 310.

Regarding the acquisition portion 302 of the preamble 300, it can be seen that the training sequences for each transmit path differ by a fixed phase amount. In this case, the phase amount is zero degrees. As the relative phase between the two paths drift (due to phase noise in the radios) and approaches π, the amplitude of the received signal approaches 0. The AGC, as a result, trains on a small amplitude signal which results in a large front-end gain and low SNR conditions. Once data symbols are transmitted however, the data symbols are random which results in a received signal with more power than the AGC training sequences. The data symbols, as a result, clip at the receiver and data decode performance suffers. The training sequences during the acquisition section 302 should be orthogonal to fix this problem so that they properly represent power level of the data symbols. They should preferably also be designed so that they are backward compatible with existing 802.11a systems.

The AGC training is not the only receiver algorithm that can suffer during the acquisition portion 302 of the preamble 300. Any course frequency correction algorithm usually functions during the short sequences of the preamble 300. If the amplitude of the received signal is approaching zero, then the course frequency correction will be in error.

It should be noted that SS₂=e^{jθ}SS₁ is not an acceptable solution to the foregoing problem because the relative phase between the two radios changes due to phase noise and it can potentially equal π−φ, which will drive the amplitude of the received signal to 0. Understanding this behavior is important for developing the training sequences in portions 304, 308 of the MIMO preamble 300. Assume now that the acquisition portions 302 of the preamble 300 has been properly designed so that the training sequences are representative of the power level of the data portion 310 (i.e. the short sequences are orthogonal). Even with this assumption, since the training sequences for part 1 (304) of channel estimation differ by a fixed phase amount (zero degrees), there will be times when the received signal for this portion of the preamble 300 is near zero because the relative phase between the two ratios is near π. Further, there will be times for part 2 (308) of channel estimation when the received signal for this portion of the preamble 300 is near zero because the relative phase between the two radios is near zero.

Any fine frequency correction algorithms that occur during part 1 (304) of the training sequences will also suffer as a result. Further, FFT placement algorithms will not function properly when the received signal has zero amplitude. Such behavior will not occur only in new MIMO systems, but in legacy systems as well. In fact, legacy systems will have an invalid channel estimate because of the zero amplitude signal; and thus, legacy decode of the SIGNAL field will not occur properly. The timing between MIMO and legacy systems, as a result, will not be synchronized and network throughput will suffer.

In view of the above, the relative phase behavior in the transmitter and receiver should be well understood when designing preamble for wireless MIMO systems. One solution is a time switched preamble for channel estimation to eliminate the potential for destructive training symbol combinations for radio configurations with independent synthesizer and large fluctuations in the relative phase value. FIG. 5 illustrates one resulting preamble 400 for a two transmitter system. It should be noted that the signal portion 406 has also been modified for backward compatibility. It should also be noted that the new channel estimation training sequences 404, 408 are scaled by \sqrt{2} (i.e. LS₁=\sqrt{2} LS) to maintain a constant transmit power level for training and data symbols.

Even with the preamble structure 400 shown in FIG. 5, it should be recognized that at a particular tone, when the phase between data values of the same magnitude and the phase between the radios differ by π, a destructive combination occurs at this particular tone.

Another important issue is phase tracking during the data symbols of a particular packet. The phase for each channel may be required to be independently tracked when a multiple synthesizer configuration is employed. The present inventors found that the phase noise in the RFMD radios in one MIMO prototype required independent phase tracking. A time switched pilot tone design, as a result, was implemented to simplify the tracking process. During a given symbol, only a single transmitter energized pilots in its symbol. The corresponding channel estimate at the receiver for that particular transmitter is then phase corrected and the other channel estimates are phase corrected using an interpolation algorithm. By alternating the pilots across transmitters, all of the channel estimates can be phase corrected with truth in N symbols.

Looking now at FIG. 6, a block diagram illustrates the transmit portion 602 of a MIMO transceiver system 600 according to one embodiment of the present invention. Each transceiver 604, 606 can be seen to use the same RF reference frequency 608; and thus each transceiver 604, 608 experiences the same phase noise. The phase noise for the MIMO transmitter 602 is therefore bounded by the single synthesizer 610. A detailed discussion of the synthesizer 610 and transceivers 604, 608 will not be set forth herein since these individual elements are well known by those skilled in the wireless communication arts as seen, for example, by the discussions set forth herein before.

With continued reference now to FIG. 6, all of the modulation paths can be seen to have the same RF frequency source. The relative phase between all of the radios in the transmit portion of the system 600, therefore is zero. Similarly, the relative phase between all of the radios in the receive portion of the system 600 are zero. The phase effects due to the transmit and receive radio in Equation (4) therefore simplify, and the received signal becomes
y₁[n]=(h₁₁[n]\hat{x}x₁[n]+h₁₂[n]\hat{x}x₂[n])e^{j(φ}^{_{T}}^{[n]+φ}^{_{R}}^{[n])} (7)
It can be seen that with respect to radio phase noise, this design converts a MIMO radio system back into a SISO radio system. This result is very advantageous from a phase track algorithm reuse perspective. The remaining phase issues that can still impact system performance are the relative phase between transmitter and receiver and those created by the wireless channels.

A significant benefit provided by the MIMO transceiver system 600 architecture then is that the relative phase in the transmitter and in the receiver has been eliminated. The low frequency effects due to phase noise, as a result, can be viewed once again as a SISO problem instead of a MIMO problem. The training sequences, with this modification, used for channel estimation in the MIMO preamble can include frequency switched designs without having destructive interference due to radio phase noise. This approach however, does not completely eliminate the potential for destructive interference because the wireless channels could still create situations where the signals at the receiver destructively combine. Time switched preambles, as a result, may still be the preferred training approach in some applications.

Since the MIMO transceiver system 600 architecture eliminates the relative phase between transmit and receive paths, it also reduces the complexity of the phase tracking algorithms in the receiver. Instead of having to track N*M phase components (i.e. one for each channel), the receiver now only has to track one phase component (i.e. the relative phase between transmitter and receiver).

The present invention is not so limited however; and it shall be understood that the embodiments described herein before apply just as well to transceivers with IF reference frequency requirements. Further, although the embodiments described herein before show only the transmit portion of the transceiver, it shall be understood that the same relative phase behavior also occurs in the receive portion of the transceiver.

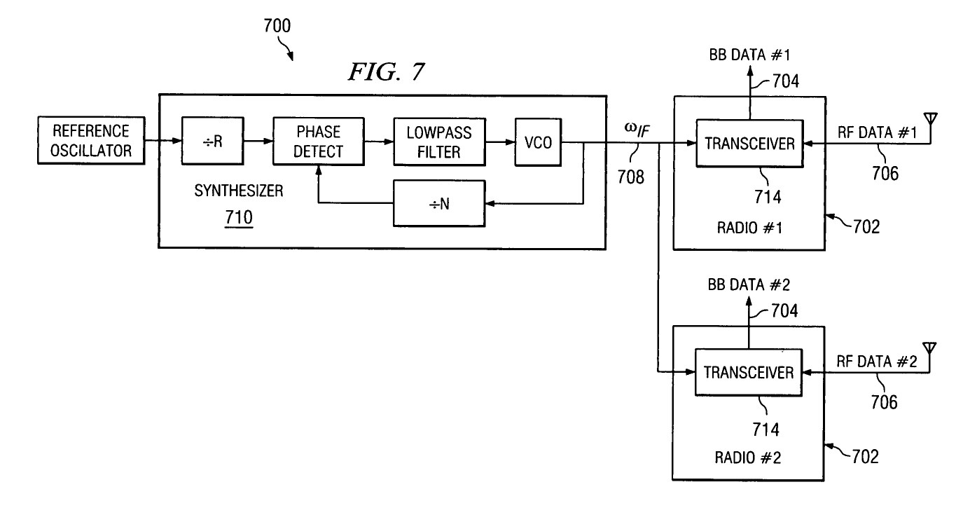

Looking now at FIG. 7, a solution to the foregoing problems was implemented by the present inventors using but a single synthesizer 710 and operating multiple transceivers 714 with the same IF reference source. FIG. 8 is a block diagram illustrating the receive portion 702 of a MIMO transceiver system 700 according to one embodiment of the present invention, and is the complement to FIG. 7 that illustrates the transmit portion 602. Each transceiver 714 can be seen to use the same IF reference frequency ω_{IF} 708; and thus each transceiver 714 experiences the same phase noise. The phase noise for the MIMO receiver 702 is therefore bounded by the single synthesizer 710. Each transceiver 714 can be seen to generate a base band signal 704 in response to the common IF reference frequency 708 and incoming RF data 706.

In summary explanation, a solution uses a single synthesizer to run multiple transceivers using the same RF/IF reference source to provide a method of eliminating the relative phase behavior in the transmitter and/or receiver radios for all of the radios in a wireless MIMO communication system. This single synthesizer approach bounds the phase noise for multiple radios in MIMO wireless communication systems, and transforms the MIMO phase noise problem into a single input single output (SISO) phase noise problem. The method employed advantageously requires fewer synthesizers, simplifies the phase tracking algorithms in the receiver, and allows implementation of frequency switched and frequency orthogonal preambles for MIMO communication systems (i.e. higher data throughput).

In view of the above, it can be seen the present invention presents a significant advancement in the art of wireless communication systems. This invention has been described in considerable detail in order to provide those skilled in the wireless MIMO communication arts with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A multiple input multiple output (MIMO) wireless communication system comprising:
a single reference oscillator;
no more than one synthesizer, the no more than one synthesizer generating a reference frequency signal in response to the single reference oscillator; and
a plurality of wireless transceivers, each wireless transceiver within the plurality of wireless transceivers responsive to the reference frequency signal and RF input data to generate RF output data.

2. The MIMO wireless communication system according to claim 1, wherein the single reference oscillator is a radio frequency (RF) reference oscillator.

3. The MIMO wireless communication system according to claim 2, wherein the reference frequency signal is a RF signal.

4. The MIMO wireless communication system according to claim 1, wherein the single reference oscillator is an intermediate frequency (IF) reference oscillator.

5. The MIMO wireless communication system according to claim 4, wherein the reference frequency signal is an IF signal.

6. The MIMO wireless communication system according to claim 1, wherein the RF input data comprises base band data.

7. The MIMO wireless communication system according to claim 1, wherein the RF output data comprises base band data.

8. A wireless communication system comprising:
means for generating a sole reference frequency output signal; and
a plurality of wireless transceivers, each wireless transceiver within the plurality of wireless transceivers responsive to the sole reference frequency output signal and a base band signal to generate RF data.

9. The wireless communication system according to claim 8, wherein the means for generating a sole reference frequency output signal comprises a sole reference oscillator.

10. The wireless communication system according to claim 9, wherein the sole reference oscillator comprises a RF oscillator.

11. The wireless communication system according to claim 10, further comprising a sole synthesizer responsive to the sole reference oscillator to generate the sole reference frequency output signal.

12. The wireless communication system according to claim 9, wherein the reference oscillator comprises an IF oscillator.

13. The wireless communication system according to claim 12, further comprising a sole synthesizer responsive to the sole reference oscillator to generate the sole reference frequency output signal.

14. A wireless communication system comprising:
means for generating a sole reference frequency output signal; and
a plurality of wireless transceivers, each wireless transceiver within the plurality of wireless transceivers operational to transmit and receive base band and RF data in response to the sole reference frequency output signal and further in response to data selected from the group consisting of RF data, and base band data.

15. The wireless communication system according to claim 14, wherein the means for generating a sole reference frequency output signal comprises:
a sole reference frequency oscillator; and
a sole transceiver operational to generate the sole reference frequency output signal in response to the sole reference frequency oscillator.

16. The wireless communication system according to claim 15, wherein the sole reference frequency output signal comprises a RF reference signal.

17. The wireless communication system according to claim 16, wherein each wireless transceiver is responsive to the sole reference frequency output signal and further responsive to incoming base band data to generate RF data.

18. The wireless communication system according to claim 15, wherein the sole reference frequency output signal comprises an IF reference signal.

19. The wireless communication system according to claim 18, wherein each wireless transceiver is responsive to the sole reference frequency output signal and further responsive to incoming RF data to generate base band data.

20. A method of wireless communication, the method comprising the steps of:
providing a single synthesizer configured to generate a RF reference frequency output signal in response to a single reference frequency oscillator; and
operating a plurality of transceivers to generate RF data in response to the RF reference frequency output signal and further in response to incoming base band data.

21. A method of wireless communication, the method comprising the steps of:
providing a single synthesizer configured to generate an IF reference frequency output signal in response to a single reference frequency oscillator; and
operating a plurality of transceivers to generate base band data in response to the IF reference frequency output signal and further in response to incoming RF data.

22. A method of wireless communication, the method comprising the steps of:
providing a single synthesizer configured to selectively generate a reference frequency output signal in response to a single reference frequency oscillator, the reference frequency output signal selected from the group consisting of a RF reference signal, and an IF reference signal; and
operating a plurality of transceivers to generate RF data when the reference frequency output signal is a RF reference signal and further to generate base band data when the reference frequency output signal is an IF reference signal.
